(19) United States
(12) Patent Application Publication
(10) Pub. No.: US 2009/0052380 A1
(43) Pub. Date: Feb. 26, 2009

(54) Mobile media router and method for using same

(76) Inventor: Joel Espelien, San Diego, CA (US)

Correspondence Address: PATENTS+TMS, P.C., 2849 W. ARMITAGE AVE., CHICAGO, IL, 60647, US

(21) Appl. No.: 12/228,475

(22) Filed: Aug. 13, 2008

Related U.S. Application Data
(60) Provisional application No. 60/965,721, filed on Aug. 21, 2007.

(51) Int. Cl. H04Q 7/00

(52) U.S. Cl. 370/328

(57) ABSTRACT

A mobile media router and a method for using the same receive multimedia data from a first wireless network and reroute the multimedia data in another format without rendering the multimedia. The mobile media router and the method for using the same may reroute the multimedia data over a second wireless network to a rendering device. The mobile media router and the method for using the same may translate, reformat and/or repackage the multimedia data into a form that allows consumption of the multimedia on the rendering device. The mobile media router and the method for using the same may reroute the multimedia data in real time so that the rendering device renders the multimedia as the multimedia data is received by the mobile media router.

This application claims the benefit of U.S. Provisional Application Ser. No. 60/965,721 filed Aug. 21, 2007.

### BACKGROUND OF THE INVENTION

The present invention generally relates to a mobile media router and a method for using the same. More specifically, the present invention relates to a mobile media router and a method for using the same that may reroute multimedia data to a rendering device. The rendering device may render the multimedia data by, for example, generating multimedia coded by the multimedia data, converting the multimedia data into an audiovisual form and/or allowing a user to view, hear and/or consume the multimedia coded by the multimedia data. The mobile media router may receive the multimedia data from a first wireless network and reroute the multimedia data in another format. The mobile media router may reroute the multimedia data without rendering the multimedia on the mobile media router. Further, the mobile media router may reroute the multimedia data over a second wireless network to the rendering device. Still further, the mobile media router may translate, reformat and/or repackage the multimedia data into a form that allows consumption of the multimedia on the rendering device. Still further, the mobile media router may reroute the multimedia data in real time so that the rendering device renders the multimedia as the multimedia data is received by the mobile media router.

Various known mobile devices, such as mobile phones, PDAs, dedicated mobile television receivers and similar devices receive digital audiovisual broadcast signals. A broadcast signal delivers digitally encoded audiovisual content to these devices. Mobile phones are used as broadband terminals and receive a variety of transmissions, such as broadcast data, multimedia data and/or other forms of data.

A user may wish to consume the audiovisual broadcast on a second device. The mobile device may not have processing power and/or display resolution to process and/or display full quality audiovisual content from the audiovisual broadcast signal. The second device may provide full quality audiovisual content from the audiovisual broadcast signal and/or better audiovisual quality relative to the mobile device.

However, the second device may not be capable of receiving the audiovisual broadcast signal. For example, the second device may not be authorized to receive a direct transmission of the audiovisual broadcast signal. As further example, the audiovisual broadcast signal may be transmitted in a format that cannot be processed by the second device. Thus, the user may wish to reroute the audiovisual broadcast signal from the mobile device to the second device by transmitting the audiovisual broadcast signal from the mobile device to the second device. The user may wish to transmit the audiovisual broadcast signal to the second device in a format that may be processed by the second device. Rerouting the audiovisual broadcast signal to the second device may allow the user to consume the audiovisual broadcast on the second device.

The user cannot reroute the audiovisual broadcast signal from a known mobile device to the second device by transmitting the audiovisual broadcast signal from the known mobile device to the second device. Known mobile devices cannot transmit the audiovisual broadcast signal to the second device. Further, known mobile devices cannot reformat the audiovisual broadcast signal into a format that may be processed by the second device. Thus, the user is prevented from consuming the audiovisual broadcast on the second device. Since the mobile device may not have the processing power and/or display resolution needed to display the full quality audiovisual content, and the audiovisual broadcast cannot be consumed on the second device, the user may choose not to consume the audiovisual broadcast or may consume the audiovisual broadcast on the mobile device at an unsatisfactory quality level.

For example, the user may receive an audiovisual broadcast signal on a known mobile phone. Known mobile phones do not allow the user to reroute the audiovisual broadcast signal to a different device, so the user is limited to consuming the audiovisual broadcast on the mobile phone. A second device such as a set-top box, a device that connects to a television and converts a signal into content displayed on the television, may provide better audiovisual quality relative to the mobile device. However, the known mobile phones do not allow a user to reroute the multimedia to the set-top box. Further, the set-top box may not be capable of receiving, processing and/or displaying the specific audiovisual broadcast signal received by the mobile device. Therefore, the user may be prevented from consuming the audiovisual content at a satisfactory audiovisual quality level.

A need, therefore, exists for a mobile media router and a method for using the same. Further, a need exists for a mobile media router and a method for using the same that receive multimedia data from a first network and reroute the multimedia data in another format without rendering the multimedia. Still further, a need exists for a mobile media router and a method for using the same that reroute the multimedia data over a second network to a rendering device. Still further, a need exists for a mobile media router and a method for using the same that translate, reformat and/or repackage the multimedia data into a form that allows consumption of the multimedia on the rendering device. Moreover, a need exists for a mobile media router and a method for using the same that reroute the multimedia data in real time so that the rendering device renders the multimedia as the multimedia data is received by the mobile media router.

### SUMMARY OF THE INVENTION

The present invention generally relates to a mobile media router and a method for using the same. More specifically, the present invention relates to a mobile media router and a method for using the same that may reroute multimedia data to a rendering device. The rendering device may render the multimedia data by, for example, generating multimedia coded by the multimedia data, converting the multimedia data into an audiovisual form and/or allowing a user to view, hear and/or consume the multimedia coded by the multimedia data. The mobile media router may receive the multimedia data from a first wireless network and reroute the multimedia data in another format. The mobile media router may reroute the multimedia data without rendering the multimedia on the mobile media router. Further, the mobile media router may reroute the multimedia data over a second wireless network to the rendering device. Still further, the mobile media router may translate, reformat and/or repackage the multimedia data into a form that allows consumption of the multimedia on the rendering device. Still further, the mobile media router may reroute the multimedia data in real time so that the rendering device renders the multimedia as the multimedia data is received by the mobile media router.

In an embodiment of the present invention, a system for routing transmission of multimedia data is provided. The system has a first wireless network; a mobile device connected to the first wireless network wherein the mobile device receives the multimedia data from the first wireless network and further wherein the first wireless network transmits the multimedia data in a first format to the mobile device; and a rendering device connected to the mobile device wherein the rendering device receives the multimedia data from the mobile device and further wherein the mobile device transmits the multimedia data to the rendering device wherein the multimedia data is consumed on the rendering device.

In an embodiment, the mobile device converts the multimedia data from the first format to a second format and transmits the multimedia data to the rendering device in the second format wherein the first format and the second format are different formats.

In an embodiment, the system has a second wireless network connected to mobile device and the rendering device wherein the mobile device transmits the multimedia data to the rendering device using the second wireless network.

In an embodiment, the system has a user interface provided by the mobile device wherein the user interface allows selection of the multimedia data and further wherein the multimedia data is transmitted to the rendering device via the mobile device in response to the selection of the multimedia data.

In an embodiment, the system has secure hardware located in the mobile device wherein the secure hardware verifies that the mobile device is authorized to receive the multimedia data from the first network.

In an embodiment, the rendering device is located remotely with respect to the mobile device.

In an embodiment, the system has a storage element in the mobile device wherein the storage element stores the multimedia data.

In an embodiment, the system has a display connected to the mobile device wherein the display provides information associated with the multimedia data.

In an embodiment, the multimedia data is a digital audiovisual multimedia file.

In an embodiment, the system has a content provider connected to the first wireless network wherein the content provider transmits the multimedia data to the mobile device via the first wireless network.

In another embodiment, a method for routing transmission of multimedia data from a first wireless network to a rendering device is provided. The method has the steps of connecting a mobile device to the first wireless network; validating that the mobile device is authorized to access the multimedia data using the first wireless network; connecting the mobile device to the rendering device; providing capability information of the rendering device to the mobile device wherein the capability information of the rendering device indicates an ability of the rendering device to process the multimedia data; transmitting the multimedia data from the first wireless network to the mobile device wherein the first wireless network transmits the multimedia data in a first format to the mobile device; converting the multimedia data from the first format to a second format wherein the first format is different than the second format and further wherein the mobile device converts the multimedia data from the first format to the second format wherein the second format is selected based on the capability information of the rendering device; and transmitting the multimedia data in the second format from the mobile device to the rendering device.

In an embodiment, the method has the step of providing capability information of the mobile device to the first wireless network wherein the capability information indicates a processing ability of the mobile device and further wherein the first format of the multimedia data is selected based on the capability information of the mobile device.

In an embodiment, the method has the step of performing decryption of the multimedia data wherein the mobile device performs decryption of the multimedia data and further wherein the decryption of the multimedia data decodes the multimedia data.

In an embodiment, the method has the step of consuming the multimedia data on the rendering device wherein the multimedia data is consumed substantially simultaneously to transmission of the multimedia data from the first wireless network to the mobile device.

In an embodiment, the multimedia data is transmitted from the mobile device to the rendering device without consumption of the multimedia data on the mobile device.

In an embodiment, the method has the step of controlling consumption of the multimedia data on the rendering device wherein the consumption of the multimedia data is controlled by input to the rendering device.

In an embodiment, the method has the step of controlling consumption of the multimedia data on the rendering device wherein the consumption of the multimedia data is controlled by input to the mobile device.

In another embodiment, a method for transmitting multimedia data from a local device to a remote device wherein the local device is connected to a first wireless network and the remote device is connected to a second wireless network and further wherein the first wireless network is a wireless local-area network and the second wireless network is a wireless wide-area network is provided. The method has the steps of connecting a mobile device to the first wireless network; providing capability information of the mobile device to the first wireless network wherein the capability information indicates processing ability of the mobile device; providing capability information of the remote device to the mobile device wherein the capability information of the remote device indicates an ability of the remote device to render the multimedia data; transmitting the multimedia data from the local device to the mobile device via the first wireless network wherein the local device transmits the multimedia data in a first format to the mobile device and further wherein the first format of the multimedia data is selected based on the capability information of the mobile device; converting the multimedia data from the first format to a second format wherein the second format is different than the first format wherein the mobile device converts the multimedia data from the first format to the second format and further wherein the second format is selected based on the capability information of the remote device; and transmitting the multimedia file in the second format from the mobile device to the remote device via the second network.

In an embodiment, the method has the step of storing the multimedia data on the mobile device wherein the multimedia data is transmitted to the remote device after the multimedia data is stored on the mobile device.

In an embodiment, the method has the step of consuming the multimedia data on the remote device wherein the multimedia data is consumed substantially simultaneously to transmission of the multimedia data from the local device to the mobile device.

It is, therefore, an advantage of the present invention to provide a mobile media router and a method for using the same.

Another advantage of the present invention is to provide a mobile media router and a method for using the same that receive multimedia data from a first wireless network and reroute the multimedia data in another format without rendering the multimedia.

And, another advantage of the present invention is to provide a mobile media router and a method for using the same that reroute the multimedia data over a second wireless network to a rendering device.

Yet another advantage of the present invention is to provide a mobile media router and a method for using the same that translate, reformat and/or repackage the multimedia data into a form that allows consumption of the multimedia on the rendering device.

Further, an advantage of the present invention is to provide a mobile media router and a method for using the same that have a broadcast receiver accessory that reroutes the multimedia data in real time so that the rendering device renders the multimedia as the multimedia data is received by the mobile media router.

Still further, an advantage of the present invention is to provide a mobile media router and a method for using the same that utilize a short range connection to transmit multimedia data to the rendering device.

Yet another advantage of the present invention is to provide a mobile media router and a method for using the same that may connect to two or more different wireless networks.

Still further, an advantage of the present invention is to provide a mobile media router and a method for using the same that parse the multimedia data, demultiplex audio and video substreams of the multimedia data, and/or perform Digital Rights Management (“DRM”) and associated decryption.

Moreover, an advantage of the present invention is to provide a mobile media router and a method for using the same that are bi-directional.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a mobile media router in an embodiment of the present invention.

FIG. 2 illustrates a flowchart of a method for using a mobile media router in an embodiment of the present invention.

FIG. 3 illustrates a flowchart of a method for using a mobile media router in an embodiment of the present invention.

### DETAILED DESCRIPTION OF THE PREFERRED EMBODIMENTS

The present invention generally relates to a mobile media router and a method for using the same. More specifically, the present invention relates to a mobile media router and a method for using the same that may reroute multimedia data to a rendering device. The rendering device may render the multimedia data by, for example, generating multimedia coded by the multimedia data, converting the multimedia data into an audiovisual form and/or allowing a user to view, hear and/or consume the multimedia coded by the multimedia data. The mobile media router may receive the multimedia data from a first wireless network and reroute the multimedia data in another format. The mobile media router may reroute the multimedia data without rendering the multimedia on the mobile media router. Further, the mobile media router may reroute the multimedia data over a second wireless network to the rendering device. Still further, the mobile media router may translate, reformat and/or repackage the multimedia data into a form that allows consumption of the multimedia on the rendering device. Still further, the mobile media router may reroute the multimedia data in real time so that the rendering device renders the multimedia as the multimedia data is received by the mobile media router.

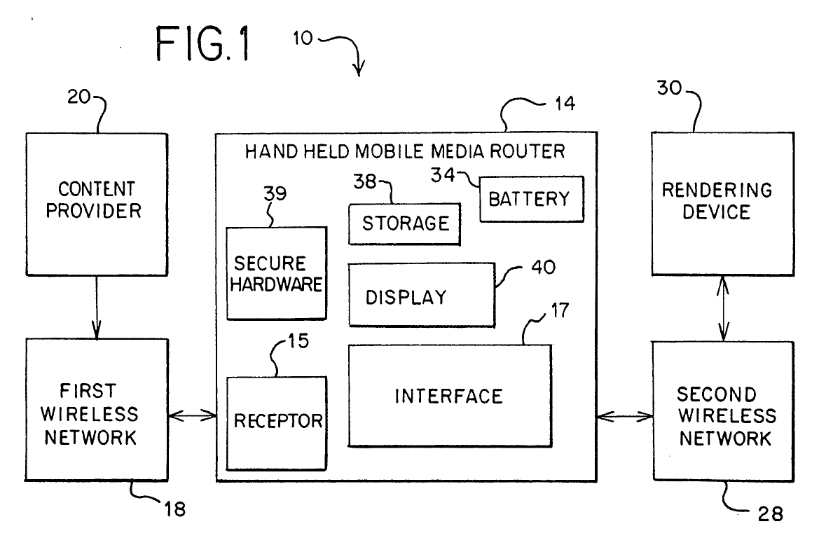

Referring now to the drawings wherein like numerals refer to like parts, FIG. 1 illustrates a system 10 which may have a mobile media router 14 that may be connected to a first data communication network 18 (hereinafter “the first network 18”)). The mobile media router 14 may receive multimedia data that may be transmitted from the first network 18. The mobile media router 14 may be, for example, a mobile device, such as, for example, a mobile cellular telephone, a personal digital assistant (“PDA”), a 4 G mobile media device, a 3 G mobile media device, a 2.5 G mobile media device, an internet protocol (hereinafter “IP”) video cellular telephone, an ALL-IP electronic device, a satellite radio receiver, a portable digital audio player, a portable digital video player and/or the like. The mobile media router 14 may be any mobile device that may receive the multimedia data from the first network 18.

The mobile media router 14 may have a receptor 15 for connecting to and/or for communicating with the first network 18. The receptor 15 may be, for example, an antenna, a sensor, a wireless card and/or the like. The receptor 13 may be any device which may receive the multimedia data as known to one having ordinary skill in the art. In addition, the mobile media router 14 may store data, such as, for example, subscription information, rating requirements, an amount of the multimedia data transmitted by the first network 18 and/or the like. The mobile media router 14 may have a display 40 that may display information relating to the multimedia data, such as, for example, a source of the multimedia data, a channel, a station, a broadcast location and/or the like. The mobile media router 14 may have a battery 34 to provide power. A battery charging mechanism (not shown) may also be provided.

Multimedia content of the multimedia data may be, for example, a digital audiovisual media file, such as, for example, an audio signal, video frames, an audiovisual stream and/or feed, an audio stream and/or feed, a video stream and/or feed, a musical composition, a radio program, an audio book and/or an audio program. Further, the digital audiovisual media file may be, for example, a cable television program, a satellite television program, a public access program, a motion picture, a music video, an animated work, a video program, a video game and/or a soundtrack and/or a video track of an audiovisual work, a dramatic work, a film score, an opera and/or the like.

The first network 18 may be, for example, an IP network, a wireless network, a wide-area network, a metropolitan area network, a paging network, a public switched telephone network and/or the like. The present invention should not be limited to a specific type or specific embodiment of the first network 18. It should be understood that the first network 18 may be any network capable of transmitting the multimedia data to the mobile media router 14 as known to one having ordinary skill in the art.

A content provider 20 may be connected to the mobile media router 14 by the first network 18. The content provider 20 may be, for example, a content service, a media store, a mobile network operator, a cable television provider, a terrestrial digital broadcast provider, a satellite television provider, a satellite radio provider, an internet radio provider, a broadband network provider, a streaming audio and/or video provider, a multimedia station, a multimedia content library, a media exchange provider and/or the like. The media station may be, for example, a television station, a radio station, a streamed radio source, a streamed video source, a satellite radio station and/or the like. The multimedia content library may be a media content retailer and/or a distributor, such as, for example, a media store, a file-sharing store, an online media distributor and/or the like. The present invention should not be limited to a specific embodiment of the content provider 20. It should be understood that the content provider 20 may be any content provider as known to one of ordinary skill in the art.

The mobile media router 14 may exchange capability information with the content provider 20 to determine a content format, audio and visual codecs, content encoding parameters and/or similar capabilities supported by the mobile media router 14. Thus, communication between the mobile media router 14 and the content provider 20 may be bidirectional. The mobile media router 14 may receive and/or may accept multiple transmissions, channels and/or stations of the multimedia data simultaneously. The multimedia data may be transmitted to the mobile media router 14 in a standardized packet format, such as, for example, Realtime Transport Protocol (RTP). The multimedia data may utilize mobile broadcasting standards, such as, for example, DVB-H (Digital Video Broadcasting-Handheld), DMB (Digital Media Broadcasting), tdTV (trademark of IPWireless, Inc.), MediaFLO (trademark of Qualcomm, Inc.), OMA BCAST (trademark of Open Mobile Alliance, Inc.), WiMax (trademark of WiMAX Forum Corporation) and 3GPP Multimedia Broadcast Multicast Service (“3GPP MBMS”). The content provider 20 may be a personalized media service specific to the mobile media router 14 that is not replicated for any other device.

A user interface 17 on the mobile media router 14, such as, for example, buttons, a touchpad, a touchscreen and/or a trackball, may allow a user to provide input to the mobile media router 14. The user interface 17 may allow the user to browse the available multimedia data, browse an electronic program guide of the available multimedia data, select a different data communication network to access and/or select the multimedia data received by the mobile media router 14 from the first network 18.

The mobile media router 14 may be connected to a second data communication network 28 (hereinafter “the second network 28”). The mobile media router 14 may transmit the multimedia information via the second network 28. The second network 28 may be a short range network, such as, for example, a wireless local-area network, a wireless Universal Serial Bus (“USB”) connection, a Wi-Fi wireless connection (trademark of Wi-Fi Alliance Corporation), and/or a Bluetooth (trademark of Bluetooth, Inc.) wireless connection. The present invention should not be limited to a specific type or specific embodiment of the second network 28. It should be understood that the second network 28 may be any network capable of transmitting the multimedia data from the mobile media router 14 as known to one having ordinary skill in the art.

The mobile media router 14 may use the second network 28 to transmit the multimedia data received from the first network 18. Alternatively, the mobile media router 14 may transmit the multimedia data directly to the rendering device 30. The mobile media router 14 may transcode network protocols, media and packet formats and/or Digital Rights Management (“DRM”) systems for transmittal of the multimedia data via the second network 28. Transcoded multimedia data may be transmitted form the mobile media router 14 to a rendering device 30 via the second network 28. Therefore, the mobile media router 14 may receive the multimedia data in a first format and may transmit the multimedia data to the rendering device 30 in a second format. The first format may be different than the second format. The first format and/or the second format may be based on and/or may correspond to requirements and/or the capabilities of the mobile media router 14 and/or the rendering device 30, respectively.

The rendering device 30 may be, for example, a computer terminal, a personal computer, a laptop computer, a media player, a game console, a mobile device, a set-top box, and/or an electronic device which may be capable of transmitting, receiving, processing, accepting and/or displaying multimedia. The set-top box may be connected to a display (not shown in the figures) for viewing, for consuming and/or for displaying the multimedia content of the multimedia data. Alternatively, the set-top box may be, for example, a digital multimedia broadcasting-enabled television and/or the like. The rendering device 30 may be any terminal capable of transmitting, receiving, processing and/or displaying the multimedia content known to one having ordinary skill in the art.

The multimedia data may have a digital transport stream. The digital transport stream may carry a multiplex. A multiplex may be a simultaneous transmission of two or more streams of signals or messages over a single channel. The multiplex may have compressed audio and/or visual bitstreams, synchronization and timing information and/or program guide information. The mobile media router 14 may provide the compressed audio bitstream, the compressed video bitstream, the synchronization and/or the timing information and the program guide information to the rendering device 30. The rendering device 30 may exchange capability information with the mobile media router 14 to determine a content format, audio and visual codecs, content encoding parameters and/or similar capabilities supported by the rendering device 30. Thus, communication between the mobile media router 14 and the rendering device 30 may be bidirectional.

The mobile media router 14 may adjust, transcode and/or transform the multimedia data to match the capabilities supported by the rendering device 30. If the rendering device 30 is capable of accepting the multimedia data without transformation, then the mobile media router 14 may transfer the content to the rendering device 30 without transcoding.

The second network 28 may be a DLNA (trademark of Digital Living Network Alliance Corporation) network. The DLNA network may be used for bidirectional communication between the mobile media router 14 and the rendering device 30. The DLNA network may act as a network between consumer electronic devices, personal computers and/or mobile devices. Devices on the DLNA network may automatically self-configure networking properties, such as, for example, an IP address, may discover the presence and/or capabilities of other devices on the DLNA network, and/or may communicate with the other devices on the DLNA network. The DLNA network may have Digital Rights Management (DRM) technologies that may enable the multimedia data to be transmitted to any device on the DLNA network, such as the mobile media router 14 and/or the rendering device 30.

The multimedia data may be encrypted. The mobile media router 14 may perform decryption of the multimedia data. The mobile media router 14 may have a key management system that may store keys necessary for the decryption of the audiovisual content. The mobile media router 14 may have secure hardware 39 that may contain the key management system and, therefore, may prevent unauthorized access to some or all of the keys necessary to perform the decryption. The secure hardware 39 may be a SIM card, a smart card, a secure digital (SD) card and/or any other secure hardware element known to one of ordinary skill in the art. The present invention should not be limited to a specific embodiment of the secure hardware 39.

Rendering of the multimedia data by the rendering device 30 may occur substantially simultaneously to receipt and/or to transcoding of the multimedia data by the mobile media router 14. In a preferred embodiment, the transcoded multimedia data may be transmitted to the rendering device 30 without rendering of the multimedia data by the mobile media router 14. The rendering device 30 may store the multimedia data for later viewing of the multimedia content of the multimedia data. Alternatively, the multimedia data may be placed in local storage 38 on the mobile media router 14 for later formatting and/or transmittal to the rendering device 30.

User input into the mobile media router 14 and/or the rendering device 30 may control consumption of the multimedia content of the multimedia data on the rendering device 30. For example, the user may select new content, change broadcast channels, pause viewing, end viewing and/or make other changes that may affect consumption of the multimedia content. Realtime Streaming Protocol (RTSP) may be used to allow a user to remotely control access, transmittal and/or consumption of the multimedia data.

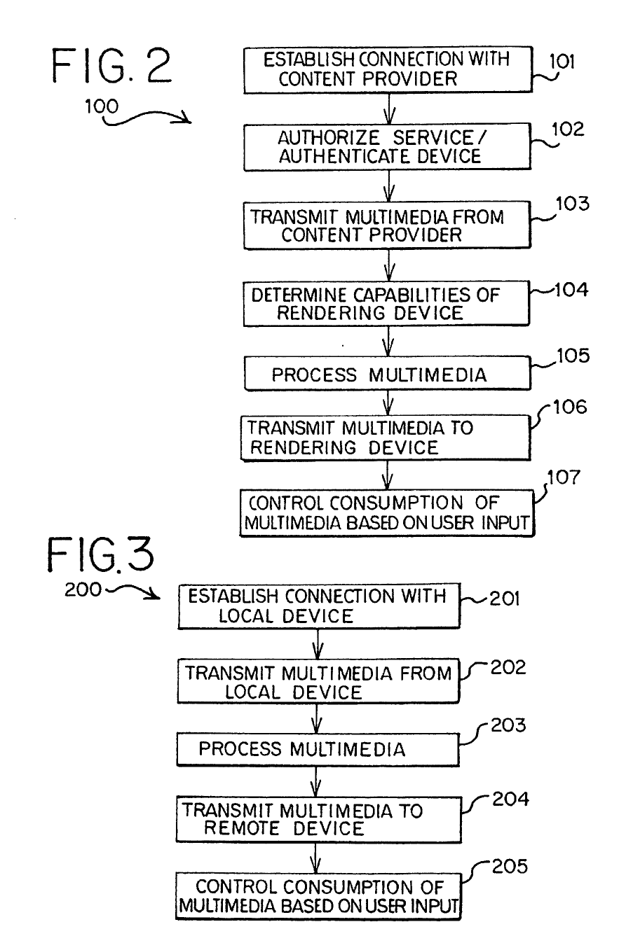

FIG. 2 generally illustrates a method 100 for using a mobile media router in an embodiment of the present invention. A connection may be initiated between the content provider 20 and the mobile media router 14 via the first network 18 as shown at step 101. Service authorization and/or authentication information may be exchanged via the connection as shown at step 102. The service authorization and/or the authentication information may be transmitted from the mobile media router 14 to the first network 18 and/or the content provider 20 to allow the mobile media router 14 to receive the multimedia data. User input may direct the mobile media router 14 to obtain the multimedia data from the first network 18 and/or the content provider 20. In a preferred embodiment, the first network 18 may be a wireless wide-area network. The multimedia data may be sent to the mobile media router 14 via the connection as shown at step 103. The user may input routing information, routing instructions and/or the like. The rendering device 30 may exchange capability information with the mobile media router 14 to determine a content format, audio and visual codecs, content encoding parameters and/or similar capabilities supported by the rendering device 30 as shown at step 104.

The multimedia data may be processed as shown at step 105. The mobile media router 14 may translate, reformat and/or repackage the multimedia data into a form that allows consumption of the multimedia on the rendering device. The mobile media router 14 may transcode network protocols, media and packet formats and/or Digital Rights Management (“DRM”) systems of the multimedia data. Transcoded multimedia data may be transmitted from the mobile media router 14 to a rendering device 30 via the second network 28 as shown at step 106. In a preferred embodiment, the second network 28 may be a wireless local-area network. The mobile media router 14 may receive the multimedia data in a first format and transmit the multimedia data to the rendering device 30 in a second format. The first format may be different than the second format. The first format and/or the second format may be based on and/or may correspond to requirements and/or the capabilities of the mobile media router 14 and the rendering device 30, respectively.

User input into the mobile media router 14 may control consumption of the multimedia as shown at step 107. For example, the user may select new content, change the broadcast channels, end viewing and/or make other changes that may affect consumption of the multimedia. The rendering device 30 may send appropriate signals to the mobile media router 14 via the connection to transmit the user input to the mobile media router 14. The mobile media router 14 may react to the user input by adjusting processing and/or transformation of the multimedia to perform commands of the user input. The input may allow content to be recorded on the mobile media router 14 for later formatting and/or transmission to the rendering device 30. The input may allow content to be stored on the rendering device 30. Thus, the content may be placed in local storage 38 on the mobile media router 14 and/or the rendering device 30 for later viewing on the rendering device 30.

FIG. 3 generally illustrates a method 200 for using a mobile media router in an embodiment of the present invention. A connection may be initiated between a local device 220 and the mobile media router 14 via the second network 28 as shown at step 201. The multimedia data may be sent to the mobile media router 14 via the connection as shown at step 202. In a preferred embodiment, the second network 28 may be a wireless local-area network. The user may input routing information, routing instructions and/or the like. The multimedia data may be processed as shown at step 203. The mobile media router 14 may translate, reformat and/or repackage the multimedia data into a form that allows consumption of the multimedia on a remote device 230. The mobile media router 14 may transcode network protocols, media and packet formats and/or Digital Rights Management (“DRM”) systems of the multimedia data. Transcoded multimedia data may be transmitted from the mobile media router 14 to the first network 18 and/or a remote device 230 via the first network 18 as shown at step 204. In a preferred embodiment, the first network 18 may be a wireless wide-area network. Therefore, the mobile media router 14 may receive the multimedia data in a first format and may transmit the multimedia data to the first network 18 in a second format. The first format may be different than the second format. The first format and/or the second format may be based on and/or may correspond to requirements and/or the capabilities of the mobile media router 14 and/or the remote device 230, respectively.

User input into the mobile media router 14 may control consumption of the multimedia as shown at step 205. For example, the user may control transmittal of the multimedia data from the local device 220 and/or may implement other changes that may affect consumption of the multimedia. The remote device 230 may send appropriate signals to the mobile media router 14 via the connection to transmit the user input to the mobile media router 14. The mobile media router 14 may react to the user input by adjusting processing and/or transformation of the multimedia to perform commands of the user input. The input may allow content to be recorded on the mobile media router 14 for later formatting and/or transmission to the remote device 230. The input may allow content to be stored on the remote device 230. Thus, the content may be placed in local storage 38 on the mobile media router 14 and/or the remote device 230 for later viewing on the rendering device 30.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for routing transmission of multimedia data, the system comprising:
a first wireless network;
a mobile device connected to the first wireless network wherein the mobile device receives the multimedia data from the first wireless network and further wherein the first wireless network transmits the multimedia data in a first format to the mobile device; and
a rendering device connected to the mobile device wherein the rendering device receives the multimedia data from the mobile device and further wherein the mobile device transmits the multimedia data to the rendering device wherein the multimedia data is consumed on the rendering device.

2. The system of claim 1 wherein the mobile device converts the multimedia data from the first format to a second format and transmits the multimedia data to the rendering device in the second format wherein the first format and the second format are different formats.

3. The system of claim 1 further comprising:
a second wireless network connected to mobile device and the rendering device wherein the mobile device transmits the multimedia data to the rendering device using the second wireless network.

4. The system of claim 1 further comprising:
a user interface provided by the mobile device wherein the user interface allows selection of the multimedia data and further wherein the multimedia data is transmitted to the rendering device via the mobile device in response to the selection of the multimedia data.

5. The system of claim 1 further comprising:
secure hardware located in the mobile device wherein the secure hardware verifies that the mobile device is authorized to receive the multimedia data from the first network.

6. The system of claim 1 wherein the rendering device is located remotely with respect to the mobile device.

7. The system of claim 1 further comprising:
a storage element in the mobile device wherein the storage element stores the multimedia data.

8. The system of claim 1 further comprising:
a display connected to the mobile device wherein the display provides information associated with the multimedia data.

9. The system of claim 1 wherein the multimedia data is a digital audiovisual multimedia file.

10. The system of claim 1 further comprising:
a content provider connected to the first wireless network wherein the content provider transmits the multimedia data to the mobile device via the first wireless network.

11. A method for routing transmission of multimedia data from a first wireless network to a rendering device, the method comprising the steps of:
connecting a mobile device to the first wireless network;
validating that the mobile device is authorized to access the multimedia data using the first wireless network;
connecting the mobile device to the rendering device;
providing capability information of the rendering device to the mobile device wherein the capability information of the rendering device indicates an ability of the rendering device to process the multimedia data;
transmitting the multimedia data from the first wireless network to the mobile device wherein the first wireless network transmits the multimedia data in a first format to the mobile device;
converting the multimedia data from the first format to a second format wherein the first format is different than the second format and further wherein the mobile device converts the multimedia data from the first format to the second format wherein the second format is selected based on the capability information of the rendering device; and
transmitting the multimedia data in the second format from the mobile device to the rendering device.

12. The method of claim 11 further comprising the step of:
providing capability information of the mobile device to the first wireless network wherein the capability information indicates a processing ability of the mobile device and further wherein the first format of the multimedia data is selected based on the capability information of the mobile device.

13. The method of claim 11 further comprising the step of:
performing decryption of the multimedia data wherein the mobile device performs decryption of the multimedia data and further wherein the decryption of the multimedia data decodes the multimedia data.

14. The method of claim 11 further comprising the step of:
consuming the multimedia data on the rendering device wherein the multimedia data is consumed substantially simultaneously to transmission of the multimedia data from the first wireless network to the mobile device.

15. The method of claim 11 wherein the multimedia data is transmitted from the mobile device to the rendering device without consumption of the multimedia data on the mobile device.

16. The method of claim 11 further comprising the step of:
controlling consumption of the multimedia data on the rendering device wherein the consumption of the multimedia data is controlled by input to the rendering device.

17. The method of claim 11 further comprising the step of:
controlling consumption of the multimedia data on the rendering device wherein the consumption of the multimedia data is controlled by input to the mobile device.

18. A method for transmitting multimedia data from a local device to a remote device wherein the local device is connected to a first wireless network and the remote device is connected to a second wireless network and further wherein the first wireless network is a wireless local-area network and the second wireless network is a wireless wide-area network, the method comprising the steps of:
connecting a mobile device to the first wireless network;
providing capability information of the mobile device to the first wireless network wherein the capability information indicates processing ability of the mobile device;
providing capability information of the remote device to the mobile device wherein the capability information of the remote device indicates an ability of the remote device to render the multimedia data;
transmitting the multimedia data from the local device to the mobile device via the first wireless network wherein the local device transmits the multimedia data in a first format to the mobile device and further wherein the first format of the multimedia data is selected based on the capability information of the mobile device;
converting the multimedia data from the first format to a second format wherein the second format is different than the first format wherein the mobile device converts the multimedia data from the first format to the second format and further wherein the second format is selected based on the capability information of the remote device; and
transmitting the multimedia file in the second format from the mobile device to the remote device via the second network.

19. The method of claim 18 further comprising the step of:
storing the multimedia data on the mobile device wherein the multimedia data is transmitted to the remote device after the multimedia data is stored on the mobile device.

20. The method of claim 18 further comprising the step of:
consuming the multimedia data on the remote device wherein the multimedia data is consumed substantially simultaneously to transmission of the multimedia data from the local device to the mobile device.
